(19) United States
(12) Patent Application Publication
(10) Pub. No.: US 2026/0025607 A1
(43) Pub. Date: Jan. 22, 2026

(54) SOUND APPARATUS AND CHAIR, VEHICULAR SEAT, AND VEHICULAR APPARATUS EACH INCLUDING THE SOUND APPARATUS

(71) Applicant: LG Display Co., Ltd., Seoul (KR)

(72) Inventors: DoHyeong KIM, Paju-si (KR); MinKyu CHOI, Paju-si (KR)

(73) Assignee: LG Display Co., Ltd., Seoul (KR)

(21) Appl. No.: 19/095,918

(22) Filed: Mar. 31, 2025

(30) Foreign Application Priority Data
Jul. 17, 2024 (KR) 10-2024-0094298

(51) Int. Cl. H04R 1/02; H04R 9/04; H04R 9/06

(52) U.S. Cl. CPC H04R 1/025; H04R 9/046; H04R 9/06; H04R 2400/03; H04R 2400/11; H04R 2499/13

(57) ABSTRACT

A sound apparatus can include an enclosure having an internal space, a vibration member connected to the enclosure and overlapping with the internal space of the enclosure, a vibration apparatus coupled to an inner surface of the enclosure and configured to vibrate the vibration member, and a plurality of vibration transmitting portions at an outer surface of the enclosure opposite to the inner surface of the enclosure. Also, the sound apparatus can further include a bracket frame accommodating the enclosure and configured to fasten the enclosure to a mounting object.

### CROSS-REFERENCE TO RELATED APPLICATIONS

This application claims the benefit of and priority to Korean Patent Application No. 10-2024-0094298 filed in Republic of Korea on Jul. 17, 2024, the entirety of which is incorporated herein by reference for all purposes.

### BACKGROUND

### Technical Field

The present disclosure relates to a sound apparatus and a chair, a vehicular seat, and a vehicular apparatus each including the sound apparatus.

### Description of the Related Art

Vehicles can include a sound apparatus which outputs a sound, based on an audio signal output from a multimedia device such as a car audio. The sound apparatus can vibrate based on a coil type including a magnet and a coil or a piezoelectric type including a piezoelectric device. For example, the sound apparatus applied to vehicles can include a front speaker and a rear speaker.

As various technologies related to vehicles advance, a demand level of passengers in vehicles is continuously increasing, and research on technology for implementing various entertainment environments inside vehicles is being conducted. For example, the entertainment environment can provide users with stereophonic sound along with tactile sensations through vibrations.

Sound apparatuses of vehicles have a limitation in implementing an entertainment environment through front and rear speakers. While increasing the number of speakers allows sound apparatuses to output stereophonic sound, there is a limitation in increasing the number of speakers due to the size of coil-type speakers and spatial constraints inside the vehicle. Also, to provide tactile feedback to users, there is a problem where it is difficult to add a separate vibration device in space-limited vehicles. Further, there exists a need for a sound apparatus that can provide a strong base sensation with high quality sound and vibrations to a user, even if the user is forcefully leaning against the sound apparatus.

### SUMMARY OF THE DISCLOSURE

The inventors have recognized the problems described above and have performed various research and experiments, which can enhance a sound characteristic and/or a sound pressure level characteristic of a vehicular sound apparatus and can implement tactile feedback through vibrations. Based on the various research and experiments, the inventors have invented a sound apparatus and a chair, a vehicular seat, and a vehicular apparatus each including the sound apparatus, which can enhance a sound characteristic and/or a sound pressure level characteristic of a vehicular sound apparatus and can implement tactile feedback through vibrations.

One or more embodiments of the present disclosure can provide a sound apparatus and a chair, a vehicular seat, and a vehicular apparatus each including the sound apparatus, which can enhance a sound characteristic and/or a sound pressure level characteristic.

One or more embodiments of the present disclosure can provide a sound apparatus and a chair, a vehicular seat, and a vehicular apparatus each including the sound apparatus, which can enhance a sound characteristic and/or a sound pressure level characteristic of a low-pitched sound band.

One or more embodiments of the present disclosure can provide a sound apparatus and a chair, a vehicular seat, and a vehicular apparatus each including the sound apparatus, which can enhance a sound characteristic and/or a sound pressure level characteristic of the low-pitched sound band and can implement tactile feedback through vibrations.

One or more embodiments of the present disclosure can provide a sound apparatus and a chair, a vehicular seat, and a vehicular apparatus each including the sound apparatus, which can implement a stereophonic sound and tactile feedback through vibrations.

Additional advantages and features of the disclosure will be set forth in part in the description which follows and in part will become apparent to those having ordinary skill in the art upon examination of the following or can be learned from practice of the disclosure. The objectives and other advantages of the disclosure can be realized and attained by the structure particularly pointed out in the written description and claims hereof as well as the appended drawings.

A sound apparatus according to one or more embodiments of the present disclosure can include an enclosure including an internal space, a vibration member connected to the enclosure and overlapping with the internal space of the enclosure, a vibration apparatus coupled to an inner surface of the enclosure and configured to vibrate the vibration member, a plurality of vibration transmitting portions at an outer surface of the enclosure opposite to the inner surface of the enclosure, and a bracket frame accommodating the enclosure and configured to fasten the enclosure to a mounting object.

A chair according to one or more embodiments of the present disclosure can include a seat part, a backrest part connected to the seat part, and at least one sound generating apparatus disposed at the backrest part and configured to output a sound toward a front surface of the backrest part. The at least one sound generating apparatus can include an enclosure including an internal space, a vibration member connected to the enclosure and overlapping with the internal space of the enclosure, a vibration apparatus coupled to an inner surface of the enclosure and configured to vibrate the vibration member, a plurality of vibration transmitting portions at an outer surface of the enclosure opposite to the inner surface of the enclosure, and a bracket frame accommodating the enclosure and configured to fasten the enclosure to a mounting object.

A vehicular seat according to one or more embodiments of the present disclosure can include a seat cushion, a seat back connected to the seat cushion, and at least one sound generating apparatus disposed at the seat back and configured to output a sound toward a front surface of the seat back. The at least one sound generating apparatus can include an enclosure including an internal space, a vibration member connected to the enclosure and overlapping with the internal space of the enclosure, a vibration apparatus coupled to an inner surface of the enclosure and configured to vibrate the vibration member, a plurality of vibration transmitting portions at an outer surface of the enclosure opposite to the inner surface of the enclosure, and a bracket frame accommodating the enclosure and configured to fasten the enclosure to a mounting object.

A vehicular apparatus according to one or more embodiments of the present disclosure can include the vehicular seat. The vehicular seat can include a seat cushion, a seat back connected to the seat cushion, and at least one sound generating apparatus disposed at the seat back and configured to output a sound toward a front surface of the seat back. The at least one sound generating apparatus can include an enclosure including an internal space, a vibration member connected to the enclosure and overlapping with the internal space of the enclosure, a vibration apparatus coupled to an inner surface of the enclosure and configured to vibrate the vibration member, a plurality of vibration transmitting portions at an outer surface of the enclosure opposite to the inner surface of the enclosure, and a bracket frame accommodating the enclosure and configured to fasten the enclosure to a mounting object.

According to one or more embodiments of the present disclosure, a sound apparatus and a chair, a vehicular seat, and a vehicular apparatus each including the sound apparatus, which can enhance a sound characteristic and/or a sound pressure level characteristic, can be provided.

According to one or more embodiments of the present disclosure, a sound apparatus and a chair, a vehicular seat, and a vehicular apparatus each including the sound apparatus, which can enhance a sound characteristic and/or a sound pressure level characteristic of a low-pitched sound band, can be provided.

According to one or more embodiments of the present disclosure, a sound apparatus and a chair, a vehicular seat, and a vehicular apparatus each including the sound apparatus, which can enhance a sound characteristic and/or a sound pressure level characteristic of the low-pitched sound band and can implement tactile feedback through vibrations, can be provided.

According to one or more embodiments of the present disclosure, a sound apparatus and a chair, a vehicular seat, and a vehicular apparatus each including the sound apparatus, which can implement a stereophonic sound and tactile feedback through vibrations, can be provided.

According to one or more embodiments of the present disclosure, a sound apparatus and a chair, a vehicular seat, and a vehicular apparatus each including the sound apparatus can implement a stereophonic sound and tactile feedback through vibrations by using a small number of speakers, thereby realizing an effect of uni-materialization.

The effects of the present disclosure are not limited to the aforesaid, but other effects not described herein will be clearly understood by those skilled in the art from the following descriptions.

The details of the present disclosure described in technical problem, technical solution, and advantageous effects do not specify essential features of claims, and thus, the scope of claims is not limited by the details described in detailed description of the invention.

### BRIEF DESCRIPTION OF THE DRAWINGS

The accompanying drawings, which are included to provide a further understanding of the disclosure, are incorporated in and constitute a part of this disclosure, illustrate aspects and embodiments of the disclosure, and together with the description serve to explain the principles and examples of the disclosure.

FIG. 1 is a diagram illustrating a sound apparatus according to an embodiment of the present disclosure.

FIG. 2 is an exploded perspective view of the sound apparatus illustrated in FIG. 1 according to an embodiment of the present disclosure.

FIG. 3 is an exploded perspective view of another direction of the sound apparatus illustrated in FIG. 1 according to an embodiment of the present disclosure.

FIG. 4 is a cross-sectional view taken along line I-I′ illustrated in FIG. 1 according to an embodiment of the present disclosure.

FIG. 5 is a diagram illustrating a vibration apparatus illustrated in FIG. 4 according to an embodiment of the present disclosure.

FIG. 6 is a diagram illustrating a state in which a sound apparatus according to an embodiment of the present disclosure is coupled to a mounting object.

FIG. 7 is a diagram illustrating sound output of a sound apparatus coupled to the mounting object illustrated in FIG. 6 according to an embodiment of the present disclosure.

FIG. 8 is a diagram illustrating a chair according to an embodiment of the present disclosure.

FIG. 9 is a diagram illustrating a vehicular seat according to an embodiment of the present disclosure.

FIG. 10 is a diagram illustrating a vehicular apparatus according to an embodiment of the present disclosure.

FIG. 11 is a diagram illustrating sound output characteristics of sound apparatuses according to an embodiment of the present disclosure and an experiment example.

Throughout the drawings and the detailed description, unless otherwise described, the same drawing reference numerals should be understood to refer to the same elements, features, and structures. The sizes, lengths, and thicknesses of layers, regions and elements, and depiction of thereof can be exaggerated for clarity, illustration, and/or convenience.

### DETAILED DESCRIPTION OF THE EMBODIMENTS

Advantages and features of the present disclosure, and implementation methods thereof, are clarified through the embodiments described with reference to the accompanying drawings. The present disclosure can, however, be embodied in different forms and should not be construed as limited to the embodiments set forth herein. Rather, these embodiments are examples and are provided so that this disclosure can be thorough and complete, to assist those skilled in the art to understand the inventive concepts without limiting the protected scope of the present disclosure.

Shapes (e.g., sizes, lengths, widths, heights, thicknesses, locations, radii, diameters, and areas), sizes, ratios, angles, numbers, and the like disclosed herein, including those illustrated in the drawings are merely examples, and thus, the present disclosure is not limited to the illustrated details. Any implementation described herein as an “example” is not necessarily to be construed as preferred or advantageous over other implementations. It is, however, noted that the relative dimensions of the components illustrated in the drawings are part of the present disclosure.

When the term “comprise,” “have,” “include,” “contain,” “constitute,” “made of,” “formed of,” or the like is used with respect to one or more elements, one or more other elements can be added unless a term such as “only” or the like is used. The terms used in the present disclosure are merely used in order to describe example embodiments, and are not intended to limit the scope of the present disclosure. The terms of a singular form can include plural forms unless the context clearly indicates otherwise.

In construing an element, the element is construed as including an error region although there is no explicit description thereof.

In describing a positional relationship, for example, when the positional order is described as “on,” “above,” “below,” “beneath,” and “next,” the situation of no contact therebetween can be included, unless “just” or “direct” is used.

If it is mentioned that a first element is positioned “on” a second element, it does not mean that the first element is essentially positioned above the second element in the figure. The upper part and the lower part of an object concerned can be changed depending on the orientation of the object. Consequently, the situation in which a first element is positioned “on” a second element includes the situation in which the first element is positioned “below” the second element as well as the situation in which the first element is positioned “above” the second element in the figure or in an actual configuration.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms. These terms are only used to distinguish one element from another. For example, a first element could be termed a second element, and, similarly, a second element could be termed a first element.

In describing elements of the present disclosure, the terms “first,” “second,” “A,” “B,” “(a),” “(b),” or the like can be used. These terms are intended to identify the corresponding element(s) from the other element(s), and these are not used to define the essence, basis, order, or number of the elements.

For the expression that an element is “connected,” “coupled,” “attached,” “adhered,” or the like to another element, the element may not only be directly connected, coupled, attached, adhered, or the like to another element, but also be indirectly connected, coupled, attached, adhered, or the like to another element with one or more intervening elements disposed or interposed between the elements, unless otherwise specified.

For the expression that an element is “contacts,” “overlaps,” or the like with another element, the element may not only directly contact, overlap, or the like with another element, but also indirectly contact, overlap, or the like with another element with one or more intervening elements disposed or interposed between the elements, unless otherwise specified.

The term “at least one” should be understood as including any and all combinations of one or more of the associated listed items. For example, “at least one among a first element, a second element and a third element” can include all combinations of two or more elements selected from the first, second and third elements as well as each element of the first, second and third elements.

Features of various embodiments of the present disclosure can be partially or entirety coupled to or combined with each other, can be technically associated with each other, and can be variously inter-operated, linked or driven together. The embodiments of the present disclosure can be implemented or carried out independently of each other, or can be implemented or carried out together in a co-dependent or related relationship. In one or more aspects, the components of each apparatus according to various embodiments of the present disclosure are operatively coupled and configured.

In the following description, various example embodiments of the present disclosure are described in detail with reference to the accompanying drawings. With respect to reference numerals to elements of each of the drawings, the same elements can be illustrated in other drawings, and like reference numerals can refer to like elements unless stated otherwise. The same or similar elements can be denoted by the same reference numerals even though they are depicted in different drawings. In addition, for convenience of description, a scale, dimension, size, and thickness of each of the elements illustrated in the accompanying drawings can be different from an actual scale, dimension, size, and thickness, and thus, embodiments of the present disclosure are not limited to a scale, dimension, size, and thickness illustrated in the drawings. Further, the term “can” fully encompasses all the meanings and coverages of the term “may” and vice versa.

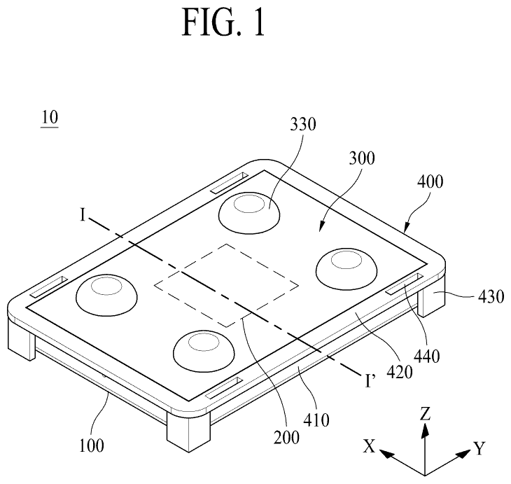

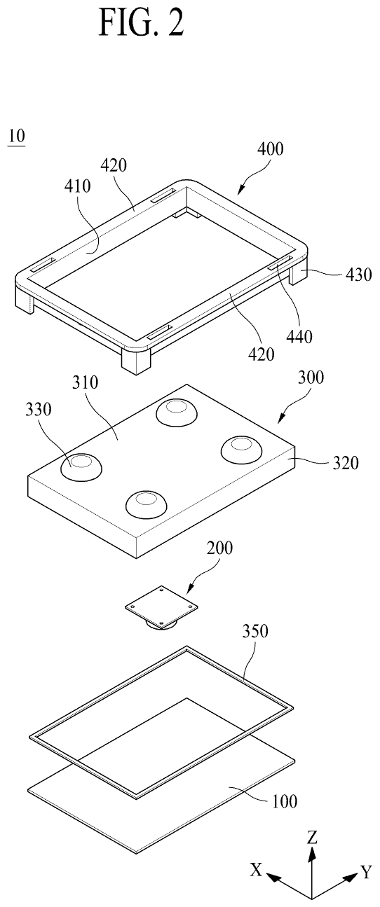

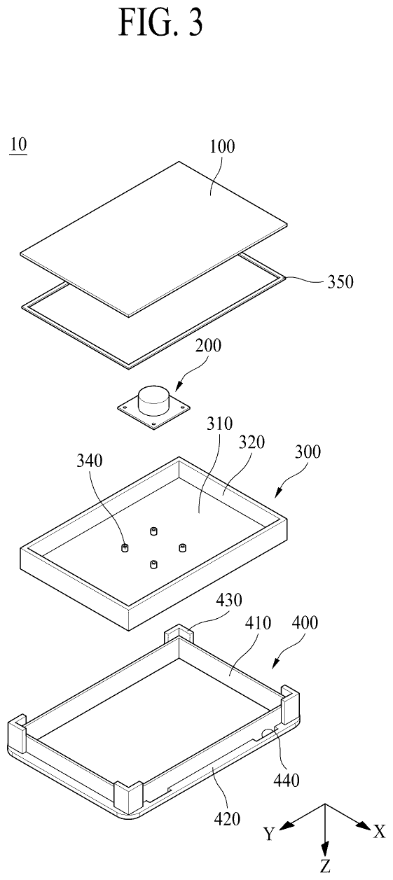

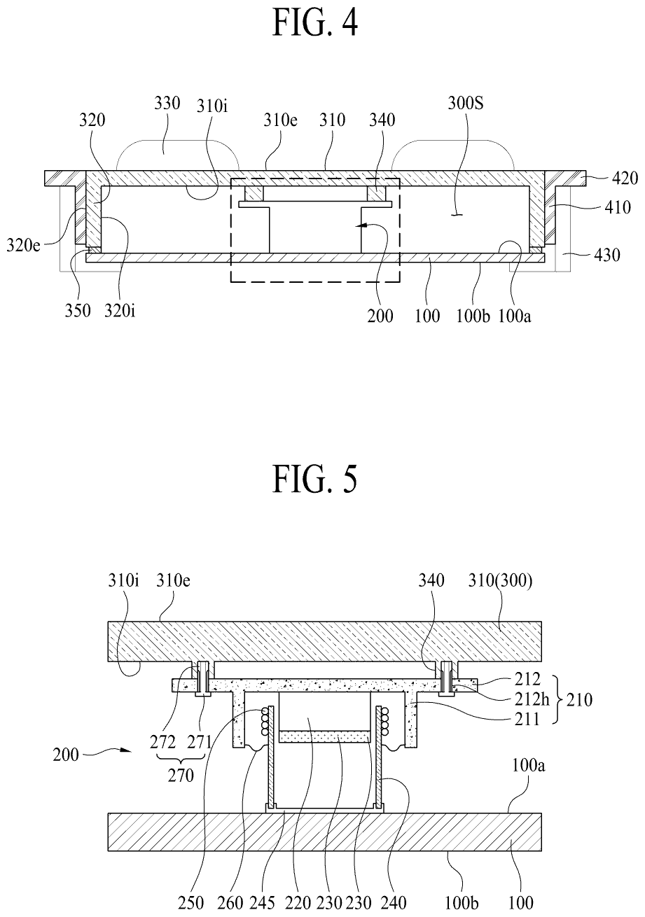

FIG. 1 is a diagram illustrating a sound apparatus according to one or more embodiments of the present disclosure. FIG. 2 is an exploded perspective view of the sound apparatus illustrated in FIG. 1 according to an embodiment of the present disclosure. FIG. 3 is an exploded perspective view of another direction of the sound apparatus illustrated in FIG. 1 according to an embodiment of the present disclosure. FIG. 4 is a cross-sectional view taken along line I-I′ illustrated in FIG. 1 according to an embodiment of the present disclosure.

Referring to FIGS. 1 to 4, a sound apparatus 10 according to an embodiment of the present disclosure can be configured to output a sound due to vibration or provide tactile feedback (or haptic feedback) due to vibration. For example, the sound apparatus 10 can be configured to output sound and the tactile feedback (or haptic feedback) due to vibration. For example, the sound apparatus 10 can be a sound output apparatus, a sound generating apparatus, a speaker, a speaker apparatus, a sound apparatus for chair, a sound output apparatus for chair, a sound generating apparatus for chair, a speaker for chair, a speaker apparatus for chair, a sound apparatus for vehicular seat, a sound output apparatus for vehicular seat, a sound generating apparatus for vehicular seat, a speaker for vehicular seat, or a speaker apparatus for vehicular seat, but embodiments of the present disclosure are not limited thereto. For example, the vehicular apparatus can include a vehicle, a train, a ship, or an aircraft, but embodiments of the present disclosure are not limited thereto.

The sound apparatus 10 according to an embodiment of the present disclosure can include a vibration member 100, a vibration apparatus 200, an enclosure 300, and a bracket frame 400.

The vibration member 100 can output a sound (or a sound wave), based on a vibration (or displacement) of the vibration apparatus 200. The vibration member 100 can be a diagram, a vibration plate, a vibration substrate, a vibration panel, a sound plate, a sound panel, a passive vibration plate, a passive vibration member, a passive vibration panel, a sound output plate, or a sound vibration plate, but embodiments of the present disclosure are not limited thereto.

The vibration member 100 can include a single nonmetal material or a complex nonmetal material, but embodiments of the present disclosure are not limited thereto. For example, the single nonmetal material or the complex nonmetal material of the vibration member 100 can include one or more materials of wood, rubber, plastic, carbon, glass, fiber, cloth, paper, mirror, and leather, but embodiments of the present disclosure are not limited thereto. For example, the paper can be cone paper for speaker. For example, the cone paper can be pulp or foam plastic, but embodiments of the present disclosure are not limited thereto.

The vibration member 100 according to an embodiment of the present disclosure can include a plastic material or a plastic material of a styrene material, but embodiments of the present disclosure are not limited thereto. For example, the plastic material of the vibration member 100 can include polyethylene terephthalate, polycarbonate, polyimide, polyimide, polypropylene, polyarylate, polyethersulfone, polyethylene naphthalate, polysulfone, cyclo-olefin copolymer, or carbon fiber reinforced plastic (CFRP), but embodiments of the present disclosure are not limited thereto. For example, the styrene material of the vibration member 100 can be an ABS material. The ABS material can be acrylonitrile, butadiene, and styrene, but embodiments of the present disclosure are not limited thereto.

According to another embodiment of the present disclosure, the vibration member 100 can include a porous material. For example, the vibration member 100 can include a micro cellular plastic material. For example, the vibration member 100 can include a polyethylene terephthalate material or a polycarbonate material, but embodiments of the present disclosure are not limited thereto. For example, the vibration member 100 can include a micro cellular polyethylene terephthalate (PET) (MCPET) material. The vibration member 100 including MCPET can be low in density, good in elastic force, and high in sound source reproduction capability, and thus, can enhance the quality of a sound.

The vibration member 100 can have a polygonal shape including a rectangular shape or a square shape, a round polygonal shape including a curve shape (or a round shape or rounded corners), a circular shape, or an oval shape, but embodiments of the present disclosure are not limited thereto.

The vibration member 100 can include a structure which has an entirely uniform thickness. For example, the vibration member 100 can include a plate structure which has an entirely uniform thickness, but embodiments of the present disclosure are not limited thereto. For example, the vibration member 100 can include a non-planar structure including a convex portion and/or a concave portion.

The vibration member 100 can include a first surface 100a and a second surface 100b opposite to the first surface 100a. For example, the first surface 100a of the vibration member 100 can be an inner surface, a rear surface, or backside surface in a direction (or a forward direction) facing the enclosure 300, and the second surface 100b of the vibration member 100 can be an outer surface or a front surface in a direction (or a forward direction) facing outside, but embodiments of the present disclosure are not limited thereto.

The vibration apparatus 200 can be configured to vibrate the vibration member 100. The vibration apparatus 200 can be configured to transmit vibrations to the enclosure 300. The vibration apparatus 200 can be coupled to the enclosure 300 and configured to vibrate the vibration member 100. The vibration apparatus 200 can be disposed or configured in an internal space 300S of the enclosure 300 to vibrate (or displace or drive) the vibration member 100. For example, the vibration apparatus 200 can be coupled to an inner surface 310i of the enclosure 300 and connected to or disposed at the first surface 100a of the vibration member 100. The vibration apparatus 200 can be connected to the first surface 100a of the vibration member 100 and provide sound to a user based on vibrations of the vibration member 100 by vibrating the vibration member 100. The vibration apparatus 200 can be coupled to the inner surface 310i of the enclosure 300, and by transferring the vibrations of the vibration apparatus 200 to the enclosure 300, tactile feedback (or haptic feedback) can be provided to the user through an outer surface 310e of the enclosure 300.

The vibration apparatus 200 can vibrate (or displace or drive) in response to a driving signal (or a vibration driving signal or a voice signal) applied from a driving circuit and can be configured to vibrate (or displace or drive) the vibration member 100. Also, the vibration apparatus 200 can vibrate (or displace or drive) in response to the driving signal (or a vibration driving signal or a voice signal) applied from the driving circuit and can be configured to transmit the vibration of the vibration apparatus 200 to the enclosure 300. For example, the vibration apparatus 200 can output a sound by using the vibration member 200 as a vibration plate. The vibration apparatus 200 can be a coil-type vibration apparatus or a coil-type actuator. For example, based on Fleming's left-hand rule, the vibration apparatus 200 can vibrate (or displace or drive) in response to the driving signal (or a vibration driving signal or a voice signal) and can be configured to out sound (or acoustic waves) or tactile feedback (or haptic feedback). For example, the vibration apparatus 200 can be a vibration generating device, a vibration generator, a vibrator, an active vibrator, an active vibration generator, an actuator, an exciter, or a transducer, but embodiments of the present disclosure are not limited thereto.

The enclosure 300 can be disposed or configured on the first surface 100a of the vibration member 100. The enclosure 300 can include an internal space 300S. The enclosure 300 can be covered by the vibration member 100 and can be configured so that the internal space 300S is provided in the first surface 100a of the vibration member 100. For example, the internal space 300S of the enclosure 300 can be surrounded by the first surface 100a of the vibration member 100 and an inner surface 310i and 320i of the enclosure 300. For example, the enclosure 300 can include a box shape where one side (or an upper side) thereof is opened, to provide (or configure) the internal space 300S. The box shape of the enclosure 300 can include a round polygonal shape including a curved portion or a tetragonal shape, but embodiments of the present disclosure are not limited thereto. For example, the enclosure 300 can be a housing, a case, an external case, a case member, a housing member, a cabinet, a scaling member, a scaling cap, a scaling box, or a sound box, but embodiments of the present disclosure are not limited thereto. For example, the internal space 300S of the enclosure 300 can be an accommodating space, a storage space, a gap space, an air space, a vibration space, a sound space, a sounding box, or a sealing space, but embodiments of the present disclosure are not limited thereto.

The enclosure 300 can include a plurality of vibration transmitting portions 330, which are disposed or configured at the outer surface 310e of the enclosure 300, opposite the inner surface 310i of the enclosure 300 where the vibration apparatus 200 is coupled. The plurality of vibration transmitting portions 330 can be disposed or configured so as not to overlap with the vibration apparatus 200. The plurality of vibration transmitting portions 330 can be configured to protrude in a vertical direction Z from the outer surface 310e of the enclosure 300. For example, the plurality of vibration transmitting portions 330 can be configured as one body with the enclosure 300. For example, the plurality of vibration transmitting portions 330 can be made of the same material as the enclosure 300, but embodiments of the present disclosure are not limited thereto. For example, the plurality of vibration transmitting portions 330 can be connected to or attached to the enclosure 300 via an adhesive member. The plurality of vibration transmitting portions 330 can be configured in a hemispherical shape, a mesa shape or dome shape. For example, the plurality of vibration transmitting portions 330 can include a flat surface at a central portion of a curved surface of the hemispherical shape, a mesa shape or dome shape.

The enclosure 300 can include one or more materials of a metal material or a nonmetal material (or a complex nonmetal material), but embodiments of the present disclosure are not limited thereto. For example, the enclosure 300 can include one or more materials of a metal material, plastic, fiber, carbon, and wood, but embodiments of the present disclosure are not limited thereto. For example, the enclosure 300 can include a plastic material or a plastic material of a styrene material, but embodiments of the present disclosure are not limited thereto. For example, the plastic material of the enclosure 300 can include polyethylene terephthalate, polycarbonate, polyimide, polyimide, polypropylene, polyarylate, polyethersulfone, polyethylene naphthalate, polysulfone, cyclo-olefin copolymer, or carbon fiber reinforced plastic (CFRP), but embodiments of the present disclosure are not limited thereto. For example, the styrene material of the enclosure 300 can be an ABS material. The ABS material can be acrylonitrile, butadiene, and styrene, but embodiments of the present disclosure are not limited thereto.

The enclosure 300 according to an embodiment of the present disclosure can include a bottom portion 310 and a supporting portion 320.

The bottom portion 310 can be configured (or disposed) in parallel with the vibration member 100. The bottom portion 310 can be configured (or disposed) in parallel with the vibration member 100 with the vibration device 200 therebetween. For example, the enclosure 300 together with the vibration member 100 can surround the vibration device 200. The bottom portion 310 can be disposed to face the first surface 100a (or the inner surface) of the vibration member 100. The bottom portion 310 can include an inner surface 310i facing the vibration member 100, and the vibration member 100 can be configured in parallel with the inner surface 310i of the bottom portion 310. The bottom portion 310 can include a polygonal shape including a curved portion or a rectangular shape, but embodiments of the present disclosure are not limited thereto.

The bottom portion 310 can include the inner surface 310i facing the vibration member 100 and the outer surface 310e opposite to the inner surface 310i. The inner surface 310i of the bottom portion 310 can be coupled to or configured to the vibration apparatus 200. The inner surface 310i of the bottom portion 310 can include a coupling portion 340 to which the vibration apparatus 200 is coupled and fixed. The coupling portion 340 can be configured to protrude in the vertical direction Z from the inner surface 310i of the bottom portion 310. For example, the vibration apparatus 200 can be configured to be spaced apart by a predetermined distance from the inner surface 310i of the bottom portion 310 by the coupling portion 340, but embodiments of the present disclosure are not limited thereto.

The plurality of vibration transmitting portions 330 can be disposed or configured on the outer surface 310e of the bottom portion 310. Also, depending upon a viewer's perspective or the perspective of a user, the bottom portion 310 could also be referred to as a top portion 310. The plurality of vibration transmitting portions 330 can be disposed or configured to not overlap with the vibration apparatus 200, which is disposed on the inner surface 310i of the bottom portion 310. For example, the plurality of vibration transmitting portions 330 can be disposed around the region of the vibration apparatus 200, in which the vibration apparatus 200 can be located at a center region among the plurality of vibration transmitting portions 330, but embodiments are not limited thereto. The plurality of vibration transmitting portions 330 can be configured to protrude in the vertical direction Z from the outer surface 310e of the bottom portion 310. For example, the plurality of vibration transmitting portions 330 can be configured as one body with the bottom portion 310. For example, the plurality of vibration transmitting portions 330 can be made of the same material as the bottom portion 310, but embodiments of the present disclosure are not limited thereto. For example, the plurality of vibration transmitting portions 330 can be connected or attached to the outer surface 310e of the bottom portion 310 via an adhesive member or coupling member. The plurality of vibration transmitting portions 330 can be configured in a hemispherical shape or a dome shape. For example, the plurality of vibration transmitting portions 330 can include a flat surface at the central portion of the curved surface of the hemispherical shape. According to another embodiment, the central portion of the curved surface of the hemispherical shape can have a textured surface, such as bumps or ridges, etc., but embodiments are not limited thereto.

The supporting portion 320 can be configured to support an edge portion of the vibration member 100 (e.g., a sidewall portion). The supporting portion 320 can be configured or disposed at the edge portion of the vibration member 100. The supporting portion 320 can be connected to an edge portion of the bottom portion 310. For example, the supporting portion 320 can be configured to protrude vertically from the edge portion of the bottom portion 310 and support the edge portion of the vibration member 100.

The supporting portion 320 can be provided as one body with the bottom portion 310. For example, the bottom portion 310 and the supporting portion 320 can be provided as one body. Therefore, the internal space 300S surrounded by the supporting portion 320 can be provided on the bottom portion 310. Accordingly, the enclosure 300 can include a box shape where one side (or an upper side) thereof is opened by the bottom portion 310 and the supporting portion 320. For example, the bottom portion 310 and supporting portion 320 together can form a five sided box space, in which one side or face remains open for receiving the vibration member 100, which can form the sixth face.

The enclosure 300 can be connected or coupled to the vibration member 100 by using a coupling member 350. The enclosure 300 can be connected or coupled to the first surface 100a (or the inner surface) of the vibration member 100 by using the coupling member 350. For example, the enclosure 300 can be connected or coupled to an edge portion of the first surface 100a of the vibration member 100 by using the coupling member 350.

The coupling member 350 according to an embodiment of the present disclosure can be configured to minimize or prevent the transfer of a vibration of the vibration member 100 to the enclosure 300. The coupling member 350 can include a material characteristic suitable for blocking of a vibration. For example, the coupling member 350 can include a material having elasticity. For example, the coupling member 350 can include a material having elasticity for vibration absorption (or impact absorption). The coupling member 350 according to an embodiment of the present disclosure can include a polyurethane material or a polyolefin material, but embodiments of the present disclosure are not limited thereto. For example, the coupling member 350 can include one or more of an adhesive, a double-sided adhesive, a double-sided tape, a double-sided adhesive tape, a double-sided foam tape, a double-sided adhesive foam tape, a double-sided pad, a double-sided foam pad, a double-sided adhesive foam pad, and a double-sided cushion tape, but embodiments of the present disclosure are not limited thereto.

According to another embodiment of the present disclosure, the coupling member 350 can minimize or prevent the transfer of a vibration of the vibration member 100 to the enclosure 300 and can be configured to decrease the reflection of a sound wave which is generated based on a vibration of the vibration member 100 and is incident thereon.

The bracket frame 400 can be configured to accommodate the enclosure 300 and to fasten the enclosure 300 to a mounting object. The bracket frame 400 can be configured to surround a perimeter of the enclosure 300. For example, the bracket frame 400 can be configured to surround the outer surface 320e of the supporting portion 320 of the enclosure 300. The bracket frame 400 can be made of a material different from that of the enclosure 300, but embodiments of the present disclosure are not limited thereto.

The bracket frame 400 according to an embodiment of the present disclosure can include a first frame 410 and a second frame 420.

The first frame 410 can be configured to surround the supporting portion 320 of the enclosure 300 and to be coupled to the outer surface 320e of the supporting portion 320. The first frame 410 can be configured to have a height lower than that of the supporting portion 320 of the enclosure 300. For example, the first frame 410 can be configured to expose the vibration member 100 connected to the enclosure 300.

The first frame 410 can include a stopper portion 430 protruding in the vertical direction Z of the second surface 100b (or outer surface) of the vibration member 100. For example, the first frame 410 can include four stopper portions 430, spaced apart from each other, at corner portions of the first frame 410. For example, the four stopper portions 430 can have a shape of four legs to space the vibration member 100 apart from a mounting object so it can move and vibrate freely, but embodiments are not limited thereto. The stopper portions 430 can be configured to protrude in the vertical direction Z of the second surface 100b of the vibration member 100 so that the second surface 100b of the vibration member 100 does not come into contact with the mounting object. For example, the second surface 100b of the vibration member 100 may not be in contact with the mounting object due to the stopper portions 430 of the first frame 410.

The second frame 420 can be configured to protrude from the first frame 410. For example, the second frame 420 can be configured to protrude in the horizontal direction X and/or Y from the side surface of the first frame 410, adjacent to the bottom portion 310 of the enclosure 300. The second frame 420 can have a flange shape or an overhang or cave shape, but embodiments are not limited thereto.

The second frame 420 can include a fastening portion 440 for fastening the enclosure 300 to the mounting object. For example, the second frame 420 can include four fastening portions 440, spaced apart from each other, at the long side portions of the second frame 420. The fastening portions 440 can be formed as through-holes or slits to accommodate fastening members for fastening the enclosure 300 to the mounting object. For example, the second frame 420 can be fastened to the mounting object by fastening members coupled to the fastening portions 440.

FIG. 5 is a diagram illustrating a vibration apparatus illustrated in FIG. 4 according to an embodiment of the present disclosure.

Referring to FIG. 5, the vibration apparatus 200 according to an embodiment of the present disclosure can include a plate 210, a magnet 220, a center pole 230, a bobbin 240, and a coil 250.

The plate 210 can be coupled to the inner surface 310i of the enclosure 300. For example, the plate 210 can be coupled and fixed to the coupling portion 340 protruding from the inner surface 310i of the enclosure 300. The plate 210 can support the magnet 220. The plate 210 can accommodate the magnet 220, the center pole 230, the bobbin 240, and the coil 250. For example, the magnet 220 can be disposed on the plate 210. For example, the center pole 230 can be disposed on the plate 210. For example, the plate 210 can be made of a thermally conductive material. For example, the plate 210 can include a first plate 211, accommodating the magnet 220, the center pole 230, the bobbin 240, and the coil 250, and a second plate 212 which protrudes from an edge of the first plate 211. The first plate 211 and the second plate 212 can be provided as one body. The first plate 211 and the second plate 212 can be integrally formed of the same thermally conductive material. For example, the first plate 211 and the second plate 212 can include a material such as iron (Fe), but embodiments of the present disclosure are not limited thereto. The first plate 211 and the second plate 212 can be referred to the other terms such as a yoke, but the terms are not limited thereto.

The first plate 211 can accommodate the magnet 220, the center pole 230, the bobbin 240, and the coil 250. For example, an inner portion of the first plate 211 can have a circular pillar shape, an oval pillar shape, or a cylinder shape. The magnet 220 can be disposed on the first plate 211, and the center pole 230 can be disposed on the magnet 220. The first plate 211 can support the magnet 220 and the center pole 230. The first plate 211 can be provided to surround the magnet 220 and the center pole 230 on the first plate 211 and the bobbin 240 and the coil 250 disposed around the center pole 230. For example, the coil 250 can be wound around an outer portion of the bobbin 240.

The second plate 212 can be formed to protrude from an edge of the first plate 211. The second plate 212 can be configured to be coupled to the inner surface 310i of the enclosure 300. The second plate 212 can be provided as one body with the first plate 211. For example, the second plate 212 can have a shape that surrounds the first plate 211. A portion of the second plate 212 can include a coupling hole 212h for coupling to the inner surface 310i of the enclosure 300. The coupling hole 212h of the second plate 212 can be disposed to correspond to the coupling portion 340 of the enclosure 300. For example, the second plate 212 can be coupled to the inner surface 310i of the enclosure 300 through the coupling portion 340 of the enclosure 300. The second plate 212 can be coupled to the enclosure 300 by the connection member 270, which is fastened to the coupling portion 340 of the enclosure 300 through the coupling hole 212h. For example, the connection member 270 can include a screw 271 and a nut 272, but embodiments are not limited thereto. The nut 272 of the connection member 270 can be fixed to the coupling portion 340 of the enclosure 300. The screw 271 of the connection member 270 can be fastened to the nut 272 fixed to the coupling portion 340 through the coupling hole 212h, and thus, can couple the second plate 212 to the inner surface 310i of the enclosure 300. For example, the nut 272 can be a self-clinching nut. Accordingly, the vibration apparatus 200 can be fixed to the enclosure 300. For example, the self-clinching nut can be a PEM® nut, but embodiments of the present disclosure are not limited thereto. The second plate 212 can be coupled to the inner surface 310i of the enclosure 300, and by transmitting the vibrations from the bobbin 240 and the coil 250 to the enclosure 300, tactile feedback (or haptic feedback) can be provided to the user through the outer surface 310e of the enclosure 300.

The magnet 220 can be disposed on the plate 210. For example, the magnet 220 can be disposed on the first plate 211 of the plate 210. A lower end of the magnet 220 can be supported by the first plate 211, and a periphery of the magnet 220 can be surrounded thereby. The magnet 220 can be disposed at a center of the inner portion of the first plate 211.

The magnet 220 can be a permanent magnet having a ring shape, a cylindrical shape, or an oval shape. The magnet 532 can be implemented with a sintered magnet such as barium ferrite, and a material of the magnet 532 can include one or more of Fe₂O₃, BaCO₃, a neodymium magnet, strontium ferrite (Fe₁₂O₁₉Sr) with improved magnet component, an alloy cast magnet including Al, nickel (Ni), and cobalt (Co). For example, the neodymium magnet can be neodymium-iron-boron (Nd—Fe—B).

The center pole 230 can be disposed on the magnet 220. The center pole 230 can be referred to as pole pieces. In another embodiment, the pole pieces can be further provided on the center pole 230.

The bobbin 240 can surround a periphery of the magnet 220. For example, the bobbin 240 can surround the magnet 220 and the center pole 230. The bobbin 240 can be disposed on the plate 210. For example, the bobbin 240 can be disposed on the first plate 211 of the plate 210. The bobbin 240 can be accommodated into the first plate 211. The bobbin 240 can be surrounded by the first plate 211. For example, the bobbin 240 can be disposed between the magnet 220 and the first plate 211.

The bobbin 240 can be connected or attached on the first surface 100a (or inner surface) of the vibration member 100. The bobbin 240 can be connected or attached on the first surface 100a (or inner surface) of the vibration member 100 through a bobbin ring 245. For example, when a current or a voice signal for generating a sound is applied to the coil 250 wound around an outer circumference surface of the bobbin 240, a whole portion of the bobbin 534 can move upward and downward according to Fleming's left-hand rule based on an application magnetic field generated around the coil 535 and an external magnetic field generated around the magnet 220. For example, the bobbin 240 can vibrate the vibration member 100 by using the bobbin ring 245. Also, the vibration member 100 can receive a vibration from the bobbin 240 or the bobbin ring 245 to generate a sound or a sound wave, and the generated sound or sound wave can be output from the second surface 100b (or outer surface) of the vibration member 100.

The bobbin 240 can include a material through which a magnet flux passes and which has low thermal conductivity. For example, the bobbin 240 can be implemented as a ring-shaped (or cylindrical or oval) structure material which includes a material obtained by processing pulp or paper, aluminum (Al), magnesium (Mg), an Al alloy, a Mg alloy, synthetic resin such as polypropylene, or polyamide-based fiber, but embodiments of the present disclosure are not limited thereto.

The coil 250 can be wound around an outer circumference surface of the bobbin 240. The coil 250 can be wound around the outer circumference surface of the bobbin 240 and can surround the magnet 220 with being apart therefrom. For example, the coil 250 can be wound around the outer circumference surface of the bobbin 240 and can surround the magnet 220 with being apart therefrom, and thus, can be supplied with a current or a voice signal, used to generate a vibration or a sound, from the outside. The coil 250 can be referred to as a voice coil. For example, the bobbin 240 and the coil 250 can be referred to as a voice coil. The coil 250 can be wound around a certain region of the bobbin 240. The coil 250 can be wound around an outer circumference surface of the bobbin 240, and the current or the voice signal for generating a vibration or a sound can be applied from the outside to the coil 250. For example, when the current or the voice signal is applied to the coil 250, the bobbin 402 can be guided according to Fleming's left-hand rule based on an application magnetic field generated around the coil 250 and a magnetic field generated around the magnet 220 to vibrate. For example, a magnet flux generated by a magnetic field can flow along a closed loop which is connected with the first plate 211, the magnet 220, the center pole 230, and the coil 250. Accordingly, the bobbin 240 can be guided by the damper 260 to vibrate and can transfer a vibration to the vibration member 100.

The damper 260 can be disposed between the first plate 211 and the bobbin 240. For example, one end (or one side) of the damper 260 can be connected with the first plate 211, and the other end (or the other side) of the damper 260 can be connected with the bobbin 240. The damper 260 can be provided in a structure which is creased between the one end and the other end thereof, and thus, can be contracted and relaxed based on a vibration of the bobbin 240 and can adjust and guide a vibration of the bobbin 240, based on a rectilinear reciprocating motion. Therefore, the damper 260 can be connected between the first plate 211 and the bobbin 240, and thus, can limit a vibration distance of the bobbin 240 by using a restoring force. For example, when the bobbin 240 moves by a certain distance or more or vibrates by a certain distance or less, the bobbin 240 can be restored to an original position with the restoring force of the damper 260. For example, the damper 260 can be referred to as other term such as an edge, a spider, or a suspension, but the terms are not limited thereto.

The bobbin ring 245 can be disposed between the bobbin 240 and the vibration member 100 and can transfer a vibration of the bobbin 240 to the vibration member 100. The bobbin ring 245 can be disposed in all of the bobbin 240, but embodiments of the present disclosure are not limited thereto and the bobbin ring 245 can be disposed at a position at which the bobbin 240 is disposed. The bobbin ring 245 can be attached on the first surface 100a (or inner surface) of the vibration member 100 by an adhesive member. For example, the adhesive member can be a double-sided tape, a single-sided tape, an adhesive, or a bond, but embodiments of the present disclosure are not limited thereto. For example, the bobbin ring 245 can prevent heat occurring in the bobbin 240 from being transferred to the vibration member 100 and can efficiently transfer a vibration of the bobbin 240 to the vibration member 100.

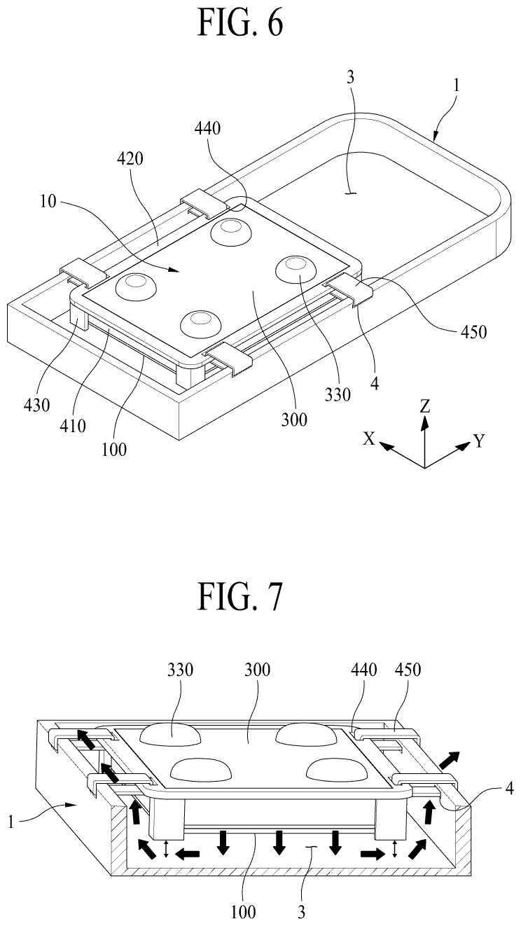

FIG. 6 is a diagram illustrating a state in which a sound apparatus according to an embodiment of the present disclosure is coupled to a mounting object. FIG. 7 is a diagram illustrating sound output of a sound apparatus coupled to the mounting object illustrated in FIG. 6 according to an embodiment of the present disclosure.

Referring to FIGS. 6 and 7, the sound apparatus 10 according to another embodiment of the present disclosure can be fastened to a mounting object 1. The mounting object 1 can be disposed or configured on or inside of a chair or a seat of a vehicle. The mounting object 1 can include an accommodating space 3 where the sound apparatus 10 can be accommodated and a fastening hole 4 where the sound apparatus 10 can be fastened. The sound apparatus 10 can be fastened to the mounting object 1 by a fastening member 450 that connects the fastening portion 440 of the bracket frame 400 and the fastening hole 4 of the mounting object 1. The fastening member 450 can be made of an elastic material. For example, the fastening member 450 can include an elastic rubber band, rubber ring, or spring, but embodiments of the present disclosure are not limited thereto. The sound apparatus 10 can be fastened within the accommodating space 3 of the mounting object 1 by the fastening member 450, and can be spaced apart from the inner surface of the accommodating space 3 of the mounting object 1. Since the fastening member 450 is configured to have elasticity, the loss of vibrations generated by the sound apparatus 10 can be prevented or minimized, thereby improving a sound characteristic and/or a sound pressure level characteristic of a low-pitched sound band. The sound apparatus 10, when fastened to the mounting object 1, can be spaced apart (e.g., floated) from the inner surface of the accommodating space 3 of the mounting object 1. As a result, the sound generated from the vibration member 100 of the sound apparatus 10 can be output smoothly in the forward direction of the mounting object 1 (e.g., toward a user or passenger), without interference within the accommodating space 3 of the mounting object 1. When the sound apparatus 10 fastened to the mounting object 1 is pushed toward the inner surface of the accommodating space 3 of the mounting object 1 by the user's contact, the vibration member 100 can be prevented from coming into contact with the inner surface of the accommodating space 3 of the mounting object 1 by the stopper portion 430 of the bracket frame 400. As a result, the sound quality distortion phenomenon of the sound output from the sound apparatus 10 can be prevented or minimized. In other words, a user can lean back against the sound apparatus 10 with considerable force, yet due to the configuration, the vibration member 100 of the sound apparatus 10 can still move freely and smoothy (e.g., remain in a floating type configuration), which can prevent impairment of the sound quality. Accordingly, the sound characteristics and/or sound pressure level characteristics of the low-pitched sound band can be further improved and a user can better feel low frequencies such a deep base which can provide a more immersive and tactile experience.

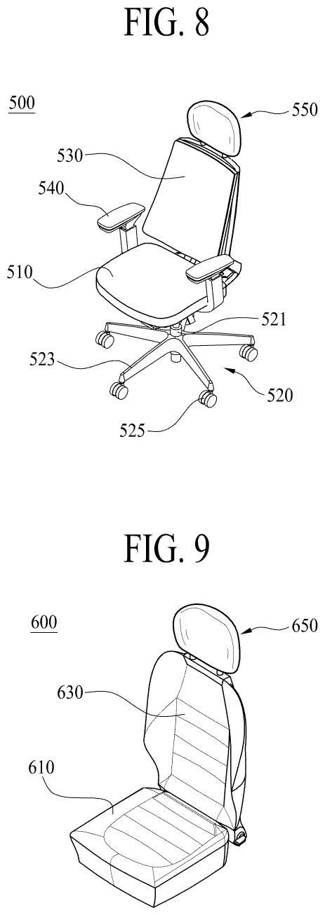

FIG. 8 is a diagram illustrating a chair according to an embodiment of the present disclosure.

Referring to FIG. 8, the chair 500 according to an embodiment of the present disclosure can be a chair for learning, an office chair, or a gaming chair, but embodiments of the present disclosure are not limited thereto.

The chair 500 according to an embodiment of the present disclosure can include a seat part 510, a backrest part 530, and a headrest 550.

The seat part 510 can be configured to enable a user to sit thereon. The seat part 510 can include a seat frame and a cushion seat supported by the seat frame.

The backrest part 530 can be configured to be connected (or coupled) to one side of the seat part 510. For example, the backrest part 530 can include a backrest frame connected (or coupled) to the one side of the seat part 510 and a backrest cushion configured on a front surface of the backrest frame. For example, the backrest part 530 can be configured to rotate (or tilt) with respect to the one side of the seat part 510.

The headrest 550 can be configured to be connected (or coupled) to an upper portion of the backrest part 530.

The backrest part 530 and/or the headrest 550 can be configured to output a sound to a user sitting on the seat part 510. For example, one or more sound apparatuses can be disposed or configured in the backrest part 530 and/or the headrest 550. A sound apparatus applied to the backrest part 530 and/or the headrest 550 according to an embodiment of the present disclosure can be configured to include the sound apparatus 10 described above with reference to FIGS. 1 to 7, and thus, its repeated description can be omitted. Also, according to an embodiment, the chair 500 can include a plurality of sound apparatuses 10.

The chair 500 according to an embodiment of the present disclosure can further include a seat supporting portion 520. The seat supporting portion 520 can include a vertical supporting portion 521 and a plurality of horizontal supporting portions 523.

The vertical supporting portion 521 can be vertically connected (or coupled) to the seat frame of the seat part 510. For example, the vertical supporting portion 521 can be configured to adjust a height of the seat part 510.

The plurality of horizontal supporting portions 523 can be supported to the ground and can be connected (or coupled) to the vertical supporting portion 521 in common. For example, the plurality of horizontal supporting portions 523 can be connected (or coupled) to the vertical supporting portion 521 to have a radial shape with respect to the vertical supporting portion 521, to stably maintain a vertical state of the vertical supporting portion 521.

The seat supporting portion 520 can further include a plurality of roller parts 525. The plurality of roller parts 525 can be respectively connected (or coupled) to the plurality of horizontal supporting portions 523. The plurality of roller parts 525 can rotate based on a movement of the chair 500 with contacting the ground. The movement of the chair 500 can be easily performed by the rotations of the plurality of roller parts 525.

The chair 500 according to an embodiment of the present disclosure can further include a pair of armrest parts 540.

The pair of armrest parts 540 can be configured to support arms of the user sitting on the seat part 510. For example, the pair of armrest parts 540 can be disposed (or configured) at one side (or a left side) and the other side (or a right side) of the seat part 510.

The chair 500 according to an embodiment of the present disclosure can provide a sound and/or a vibration to the user sitting on the seat part 510 through the backrest part 530 and/or the headrest 550. For example, the chair 500 can provide tactile feedback (or haptic feedback) or a stereophonic sound to the user sitting on the seat part 510 through the backrest part 530 and/or the headrest 550.

FIG. 9 is a diagram illustrating a vehicular seat according to an embodiment of the present disclosure.

Referring to FIG. 9, the vehicular seat 600 according to an embodiment of the present disclosure can be a driver seat, a front passenger seat, a back seat, or a baby car seat, but embodiments of the present disclosure are not limited thereto.

The vehicular seat 600 according to an embodiment of the present disclosure can include a seat cushion 610, a seat back 630, and a headrest 650.

The seat cushion 610 can be configured so that a passenger of a vehicular apparatus is sit thereon. The seat cushion 610 can include a seat frame and a seat cushion supported by the seat frame.

The seat back 630 can be configured to be connected (or coupled) to one side of the seat cushion 610. For example, the seat back 630 can include a seat back frame connected (or coupled) to the one side of the seat cushion 610 and a seat back cushion configured at a front surface of the seat back frame. For example, the seat back 630 can be configured to rotate (or tilt) with respect to the one side of the seat cushion 610.

The headrest 650 can be configured to be connected to (or supported by) an upper portion of the seat back 630.

The seat back 630 can be configured to output a sound and/or a vibration to a passenger sitting on the seat cushion 610. For example, one or more sound apparatuses can be disposed or configured in the seat back 630. A sound apparatus applied to the seat back 630 according to an embodiment of the present disclosure can be configured to include the sound apparatus 10 described above with reference to FIGS. 1 to 7, and thus, its repeated description can be omitted. Also, according to an embodiment, the vehicular seat 600 can include a plurality of sound apparatuses 10.

The vehicular seat 600 according to an embodiment of the present disclosure can provide a sound and/or a vibration to the passenger sitting on the seat cushion 610 through the seat back 630. For example, the vehicular seat 600 can provide tactile feedback (or haptic feedback) or a stereophonic sound to the passenger sitting on the seat cushion 610 through the seat back 630.

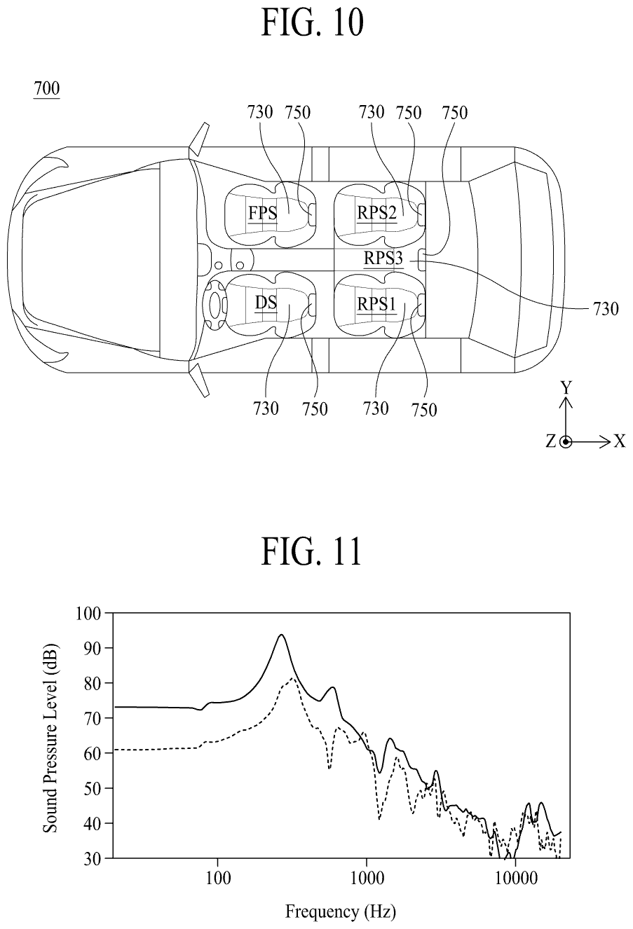

FIG. 10 is a diagram illustrating a vehicular apparatus according to an embodiment of the present disclosure.

Referring to FIG. 10, the vehicular apparatus 700 according to an embodiment of the present disclosure can include a driver seat DS, a front passenger seat FPS, and a plurality of rear passenger seats RPS1 to RPS3.

Each of the driver seat DS and the front passenger seat FPS can be a front seat. Each of the driver seat DS and the front passenger seat FPS can include a seat back 730 and a headrest 750.

One or more sound apparatuses can be disposed or configured in the seat back 730 of each of the driver seat DS and the front passenger seat FPS according to an embodiment of the present disclosure. A sound apparatus applied to the seat back 730 according to an embodiment of the present disclosure can be configured to include the sound apparatus 10 described above with reference to FIGS. 1 to 7, and thus, its repeated description can be omitted.

The seat back 730 of the driver seat DS can provide tactile feedback (or haptic feedback) or a stereophonic sound to a driver.

The seat back 730 of the front passenger seat FPS can provide tactile feedback (or haptic feedback) or a stereophonic sound to a passenger sitting on the front passenger seat FPS.

Each of the plurality of rear passenger seats RPS1 to RPS3 can include a seat back 730 and a headrest 750. The seat back 730 of each of the plurality of rear passenger seats RPS1 to RPS3 according to an embodiment of the present disclosure can be configured to include the sound apparatus 10 described above with reference to FIGS. 1 to 7, and thus, their repeated descriptions can be omitted.

The seat back 730 of each of the plurality of rear passenger seats RPS1 to RPS3 can provide tactile feedback (or haptic feedback) or a stereophonic sound to a passenger sitting on each of the plurality of rear passenger seats RPS1 to RPS3.

According to another embodiment of the present disclosure, the vehicular apparatus 700 can be configured to include the vehicular seat 600 described above with reference to FIG. 9. For example, one or more of the driver seat DS, the front passenger seat FPS, and the rear passenger seats RPS1 to RPS3 of the vehicular apparatus 700 can be configured to include the vehicular seat 600 described above with reference to FIG. 9, and thus, their repeated descriptions can be omitted.

The vehicular apparatus 700 according to an embodiment of the present disclosure can provide tactile feedback (or haptic feedback) or a stereophonic sound to a passenger sitting on a corresponding seat through the seat back 730 of one or more of the driver seat DS, the front passenger seat FPS, and the plurality of rear passenger seats RPS1 to RPS3.

FIG. 11 is a diagram illustrating sound output characteristics of sound apparatuses according to an embodiment of the present disclosure and an experiment example.

In FIG. 11, the abscissa axis represents the frequency (Hz), and the ordinate axis represents the sound pressure level (SPL) (dB). A solid line represents the sound output characteristic of the sound apparatus 10 including the bracket frame 400 of FIGS. 1 to 7. A dotted line represents a sound output characteristic of a sound apparatus that does not include the bracket frame.

A sound output characteristic can be measured by a sound analysis apparatus. The sound analysis apparatus can include a sound card which transmits or receives a sound to or from a control personal computer (PC), an amplifier which amplifies a signal generated from the sound card and transfers the amplified signal to a vibration apparatus, and a microphone which collects a sound generated based on driving of the vibration apparatus. The sound collected through the microphone can be input to the control PC through the sound card, and a control program can check the input sound to analyze a sound output characteristic of the vibration apparatus.

A sound output characteristic has been measured in an anechoic chamber which is closed in all directions. A separation distance between the sound apparatus and the microphone has been set to 0.3 m. However, a method of measuring a sound output characteristic is not limited thereto.

Referring to FIG. 11, comparing with the dotted line, in the solid line, it can be seen that a sound pressure level of a low-pitched sound band is enhanced.

Comparing with the dotted line, in the solid line, it can be seen that the sound pressure level increases in the low-pitched sound band of 1 kHz and below. For example, comparing with the dotted line, in the solid line, it can be seen that the sound pressure level increases by about 15 dB or more at 250 Hz. Comparing with the dotted line, in the solid line, it can be seen that a sound pressure level increases by about 13 dB or more in 500 Hz. Accordingly, in the sound apparatus according to an embodiment of the present disclosure, a sound characteristic and/or a sound pressure level characteristic of the low-pitched sound band of 1 kHz and below can be enhanced. For example, the sound apparatus according to an embodiment of the present disclosure can provide a much stronger base sensation to a user, even if the user is leaning against the sound apparatus.

A sound apparatus and a chair, a vehicular seat, and a vehicular apparatus each including the sound apparatus according to one or more embodiments of the present disclosure will be described below. These are provided as examples, and do not limit the scope of the present disclosure.

A sound apparatus according to one or more embodiments of the present disclosure can include an enclosure including an internal space, a vibration member connected to the enclosure and overlapping with the internal space of the enclosure, a vibration apparatus coupled to an inner surface of the enclosure and configured to vibrate the vibration member, a plurality of vibration transmitting portions at an outer surface of the enclosure opposite to the inner surface of the enclosure, and a bracket frame accommodating the enclosure and configured to fasten the enclosure to a mounting object.

According to one or more embodiments of the present disclosure, the vibration apparatus can include a plate coupled to the inner surface of the enclosure, a magnet on the plate, a bobbin around the magnet, and a coil around the bobbin.

According to one or more embodiments of the present disclosure, the plate can include a first plate accommodating the magnet, the bobbin, and the coil, and a second plate protruding from an edge of the first plate and coupled to the inner surface of the enclosure.

According to one or more embodiments of the present disclosure, the second plate can be coupled to the inner surface of the enclosure through a coupling portion protruding the inner surface of the enclosure.

According to one or more embodiments of the present disclosure, the plurality of vibration transmitting portions can do not overlap with the vibration apparatus.

According to one or more embodiments of the present disclosure, the plurality of vibration transmitting portions can protrude in a vertical direction from the outer surface of the enclosure.

According to one or more embodiments of the present disclosure, the plurality of vibration transmitting portions can be configured as one body with the enclosure.

According to one or more embodiments of the present disclosure, the plurality of vibration transmitting portions can be configured in a hemispherical shape, a mesa shape or a dome shape.

According to one or more embodiments of the present disclosure, the plurality of vibration transmitting portions can have a flat surface at a central portion of a curved surface of the hemispherical shape.

According to one or more embodiments of the present disclosure, the enclosure can include a bottom portion including the inner surface facing the vibration member, and a supporting portion configured to protrude from an edge of the bottom portion and support the edge of the vibration member, and the bracket frame can be configured to surround an outer surface of the supporting portion of the enclosure.

According to one or more embodiments of the present disclosure, the bracket frame can be made of a material different from a material of the enclosure.

According to one or more embodiments of the present disclosure, the bracket frame can include a first frame surrounding the supporting portion of the enclosure and coupled to the outer surface of the supporting portion, and a second frame protruding from a side surface of the first frame adjacent to the bottom portion of the enclosure, the second frame including a fastening portion that is fastened to the mounting object.

According to one or more embodiments of the present disclosure, the sound apparatus can further include a fastening member configured to fasten the fastening portion of the second frame to the mounting object, the fastening member can be made of an elastic material.

According to one or more embodiments of the present disclosure, the first frame can be configured to have a height lower than a height of the supporting portion of the enclosure.

According to one or more embodiments of the present disclosure, the first frame can be configured to expose the vibration member connected to the enclosure.

According to one or more embodiments of the present disclosure, the vibration member can include a first surface facing the enclosure and a second surface opposite to the first surface, and the first frame can include a stopper portion protruding in a vertical direction of the second surface of the vibration member.

According to one or more embodiments of the present disclosure, the stopper portion can be disposed at a corner portion of the first frame.

According to one or more embodiments of the present disclosure, the vibration member can include one or more materials of metal, wood, rubber, plastic, carbon, glass, fiber, cloth, paper, mirror, and leather.

A chair according to one or more embodiments of the present disclosure can include a seat part, a backrest part connected to the seat part, and at least one sound generating apparatus disposed at the backrest part and configured to output a sound toward a front surface of the backrest part. The at least one sound generating apparatus can include an enclosure including an internal space, a vibration member connected to the enclosure and overlapping with the internal space of the enclosure, a vibration apparatus coupled to an inner surface of the enclosure and configured to vibrate the vibration member, a plurality of vibration transmitting portions at an outer surface of the enclosure opposite to the inner surface of the enclosure, and a bracket frame accommodating the enclosure and configured to fasten the enclosure to a mounting object.

A vehicular seat according to one or more embodiments of the present disclosure can include a seat cushion, a seat back connected to the seat cushion, and at least one sound generating apparatus disposed at the seat back and configured to output a sound toward a front surface of the seat back. The at least one sound generating apparatus can include an enclosure including an internal space, a vibration member connected to the enclosure and overlapping with the internal space of the enclosure, a vibration apparatus coupled to an inner surface of the enclosure and configured to vibrate the vibration member, a plurality of vibration transmitting portions at an outer surface of the enclosure opposite to the inner surface of the enclosure, and a bracket frame accommodating the enclosure and configured to fasten the enclosure to a mounting object.

A vehicular apparatus according to one or more embodiments of the present disclosure can include the vehicular seat. The vehicular seat can include a seat cushion, a seat back connected to the seat cushion, and at least one sound generating apparatus disposed at the seat back and configured to output a sound toward a front surface of the seat back. The at least one sound generating apparatus can include an enclosure including an internal space, a vibration member connected to the enclosure and overlapping with the internal space of the enclosure, a vibration apparatus coupled to an inner surface of the enclosure and configured to vibrate the vibration member, a plurality of vibration transmitting portions at an outer surface of the enclosure opposite to the inner surface of the enclosure, and a bracket frame accommodating the enclosure and configured to fasten the enclosure to a mounting object.

The above-described feature, structure, and effect of the present disclosure are included in at least one embodiment of the present disclosure, but are not limited to only one embodiment. Furthermore, the feature, structure, and effect described in at least one embodiment of the present disclosure can be implemented through combination or modification of other embodiments by those skilled in the art. Therefore, content associated with the combination and modification should be construed as being within the scope of the present disclosure.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the appended claims and their equivalents.

What is claimed is:

1. A sound apparatus comprising:
an enclosure including an internal space;
a vibration member connected to the enclosure and overlapping with the internal space of the enclosure;
a vibration apparatus coupled to an inner surface of the enclosure and configured to vibrate the vibration member;
a plurality of vibration transmitting portions at an outer surface of the enclosure opposite to the inner surface of the enclosure; and
a bracket frame accommodating the enclosure and configured to fasten the enclosure to a mounting object.

2. The sound apparatus of claim 1, wherein the vibration apparatus includes:
a plate coupled to the inner surface of the enclosure;
a magnet on the plate;
a bobbin around the magnet; and
a coil around the bobbin.

3. The sound apparatus of claim 2, wherein the plate includes:
a first plate accommodating the magnet, the bobbin, and the coil; and
a second plate protruding from an edge of the first plate and coupled to the inner surface of the enclosure.

4. The sound apparatus of claim 3, wherein the second plate is coupled to the inner surface of the enclosure through a coupling portion protruding from the inner surface of the enclosure.

5. The sound apparatus of claim 1, wherein the plurality of vibration transmitting portions do not overlap with the vibration apparatus and protrude in a vertical direction from the outer surface of the enclosure.

6. The sound apparatus of claim 1, wherein the plurality of vibration transmitting portions are configured as one body with the enclosure.

7. The sound apparatus of claim 1, wherein the plurality of vibration transmitting portions are configured in a hemispherical shape, a mesa shape or a dome shape.

8. The sound apparatus of claim 7, wherein the plurality of vibration transmitting portions have a flat surface at a central portion of a curved surface of the hemispherical shape.

9. The sound apparatus of claim 1, wherein the enclosure includes:
a bottom portion including the inner surface facing the vibration member; and
a supporting portion configured to protrude from an edge of the bottom portion and support the edge of the vibration member, and
wherein the bracket frame is configured to surround an outer surface of the supporting portion of the enclosure.

10. The sound apparatus of claim 9, wherein the bracket frame is made of a material different from a material of the enclosure.

11. The sound apparatus of claim 9, wherein the bracket frame includes:
a first frame surrounding the supporting portion of the enclosure and coupled to the outer surface of the supporting portion; and
a second frame protruding from a side surface of the first frame adjacent to the bottom portion of the enclosure, the second frame including a fastening portion that is fastened to the mounting object.

12. The sound apparatus of claim 11, further comprising a fastening member configured to fasten the fastening portion of the second frame to the mounting object,
wherein the fastening member is made of an elastic material.

13. The sound apparatus of claim 11, wherein the first frame is configured to have a height lower than a height of the supporting portion of the enclosure.

14. The sound apparatus of claim 11, wherein the first frame is configured to expose the vibration member connected to the enclosure.

15. The sound apparatus of claim 14, wherein the vibration member includes a first surface facing the enclosure and a second surface opposite to the first surface, and
wherein the first frame includes a stopper portion protruding in a vertical direction of the second surface of the vibration member.

16. The sound apparatus of claim 15, wherein the stopper portion is disposed at a corner portion of the first frame.

17. The sound apparatus of claim 1, wherein the vibration member includes one or more materials of metal, wood, rubber, plastic, carbon, glass, fiber, cloth, paper, mirror, and leather.

18. A chair comprising:
a seat part;
a backrest part connected to the seat part; and
at least one sound generating apparatus disposed at the backrest part and configured to output a sound toward a front surface of the backrest part,
wherein the at least one sound generating apparatus includes the sound apparatus of claim 1.

19. A vehicular seat comprising:
a seat cushion;
a seat back connected to the seat cushion; and
at least one sound generating apparatus disposed at the seat back and configured to output a sound toward a front surface of the seat back,
wherein the at least one sound generating apparatus includes the sound apparatus of claim 1.

20. A vehicular apparatus comprising the vehicular seat of claim 19.
